(19) United States
(12) Patent Application Publication
(10) Pub. No.: US 2025/0148450 A1
(43) Pub. Date: May 8, 2025

(54) GAS STATION INFORMATION-PROVISION SYSTEM AND METHOD

(71) Applicants: HYUNDAI MOTOR COMPANY, Seoul (KR); KIA CORPORATION, Seoul (KR)

(72) Inventors: Seung Yeon Lee, Seoul (KR); Dae Kun Lee, Yongin-si (KR); La Woo Kim, Seoul (KR)

(73) Assignees: HYUNDAI MOTOR COMPANY, Seoul (KR); KIA CORPORATION, Seoul (KR)

(21) Appl. No.: 18/654,539

(22) Filed: May 3, 2024

(30) Foreign Application Priority Data
Nov. 6, 2023 (KR) 10-2023-0151858

(51) Int. Cl. G06Q 20/32; G07C 5/08

(52) U.S. Cl. CPC G06Q 20/326; G07C 5/0808; G07C 5/0841

(57) ABSTRACT

A gas station information-provision system includes a determination part configured to determine a vehicle's fueling history using a first fuel type among a plurality of types of fuel. The system also includes an execution part configured to output gas station information about a gas station available for fueling with the first-type fuel, if a preset condition according to the fueling history with the first fuel type is satisfied.

### CROSS REFERENCE TO RELATED APPLICATION

The present application claims priority to Korean Patent Application No. 10-2023-0151858 filed on Nov. 6, 2023, the entire contents of which are incorporated herein for all purposes by this reference.

### BACKGROUND

### Field of the Disclosure

The present disclosure relates to a gas station information-provision system and to a method for providing gas station information that may be of interest to a user based on a vehicle's fueling history.

### Description of the Related Art

A vehicle's navigation system is intended to provide optimal guidance to a driver, providing route information and map information according to various options such as the minimum time and shortest distance to the user's (e.g., driver's) desired destination.

Although navigation systems were originally designed to perform the above functions, recent advances in related technologies have enabled navigation systems to perform not only just a function of providing routes, but also a variety of functions, including radio, media, built-in camera, weather, phone, payment, vehicle system diagnosis, and communication. As a result, the term AVNT (Audio, Video, Navigation, Telematics) is gaining widespread acceptance. Thus, applicability is expanding as various information, in addition to the route and map information of the navigation systems, may be provided by a single device.

The foregoing is intended merely to aid in understanding the background of the present disclosure. The foregoing is not intended to mean that the present disclosure falls within the purview of the related art that is already known to those of ordinary skill in the art.

### SUMMARY

An objective of the present disclosure is to provide gas station information that may be of interest to a user, such as a driver, based on the vehicle's fueling history.

Objectives of the present disclosure are not limited to the above objective. Other objectives not mentioned herein should be apparent to those or ordinary skill in the art from the following description.

In an aspect of the present disclosure, a gas station information-provision system includes a determination part configured to determine a vehicle's fueling history using a first fuel type among a plurality of types of fuel. The system also includes an execution part configured to output gas station information about a gas station available for fueling with the first fuel type, if a preset condition according to the fueling history using the first fuel type is satisfied.

For example, the first fuel type may have a higher octane number than a second fuel type among the plurality of types of fuel.

For example, the determination part may determine the fueling history using the first fuel type from at least one of a payment history of a payment system associated with the vehicle to provide a fueling payment service, a detection result of a knocking sensor provided on a side of an engine of the vehicle to detect knocking occurring during operation of the engine, or a combination thereof.

For example, the payment system may be configured such that at least some components of the payment system are mounted in the vehicle.

For example, the determination part may determine the fueling history using the first fuel type on the basis of a number of knocking detections according to the detection result of the knocking sensor.

For example, if the fueling history using the first fuel type is not obtained from the payment history of the payment system, the determination part may determine the fueling history using the first fuel type from the detection result of the knocking sensor.

For example, the determination part may analyze a fueling pattern with the first fuel type based on the determined fueling history using the first fuel type. Satisfaction of the preset condition may be determined based on the analyzed fueling pattern with the first fuel type.

For example, the fueling pattern with the first fuel type may include at least one of a fueling cycle with the first fuel type, a fueling location with the first fuel type, a fueling history with a second fuel type among the plurality types of fuel, a fueling frequency with the first fuel type relative to the second fuel type, or any combination thereof.

For example, the determination part may determine the fueling frequency with the first fuel type relative to the second fuel type depending on a change in a number of knocking detections from the detection result of the knocking sensor.

For example, the determination part may further consider a detection result of a fuel sensor provided in the vehicle to analyze the fueling pattern with the first fuel type.

For example, the determination part may determine at least one of a fueling location, a fueling time, or a combination thereof for the vehicle depending on a change in fuel volume according to the detection result of the fuel sensor to analyze the fueling pattern with the first fuel type.

For example, the gas station information-provision system may further include a prediction part configured to determine an optimal fueling time for the first fuel type depending on the fueling pattern with the first fuel type analyzed by the determination part. Satisfaction of the preset condition may be determined based on the optimal fueling time.

For example, the gas station information may include at least one of brand information, location information, price information, discount information, or any combination thereof for the gas station.

For example, the execution part may output, among gas station information about gas stations available for fueling with the first fuel type, gas station information about gas stations located around the current location of the vehicle.

For example, the execution part may output the gas station information such that the gas station information is recognized within the vehicle via at least one of visual sense, auditory sense, or a combination thereof.

For example, the execution part may output the gas station information so that the gas station information is displayed on a map screen of a display device provided in the vehicle within a certain range based on the current location of the vehicle displayed on the map screen.

In another aspect of the present disclosure, a gas station information-provision method includes determining a vehicle's fueling history using a first fuel type among a plurality types of fuel. The method also includes, if a preset condition according to the fueling history using the first fuel type is satisfied, outputting gas station information about gas stations available for fueling with the first fuel type.

According to various embodiments of the present disclosure, it is possible to provide customized gas station advertisements reflecting personal preferences by providing gas station information based on the fueling history of a user such as a driver.

In particular, by analyzing the fueling pattern of high-grade fuel and providing gas station information accordingly, it is possible to provide effective customized advertisements to consumers of high-grade fuel.

In addition, it is possible to guide, to users such as drivers, the appropriate fueling time by using the fueling pattern and the gas station information.

In addition, by linking with an in-vehicle payment system, it is possible to induce the use of the in-vehicle payment system.

The effects available from the present disclosure are not limited to those mentioned above. Other effects, not mentioned herein, should be more clearly understood by one having ordinary skill in the technical field to which the present disclosure belongs from the following description.

### BRIEF DESCRIPTION OF THE DRAWINGS

FIG. 1 is a diagram illustrating a configuration of a gas station information-provision system according to an embodiment of the present disclosure.

FIG. 2 is a diagram illustrating a manner of providing a gas station information-provision according to an embodiment of the present disclosure.

FIG. 3 is a flowchart illustrating a gas station information-provision method according to an embodiment of the present disclosure.

### DETAILED DESCRIPTION

Specific structural or functional descriptions of the embodiments of the present disclosure disclosed in this specification or application are merely exemplified for the purpose of illustrating the embodiments according to the present disclosure. The embodiments of the present disclosure may be implemented in various forms and should not be construed as being limited to the embodiments described in this specification or application.

Since the embodiments according to the present disclosure can be diversely modified into various forms, only specific embodiments are illustrated and described in detail in the drawings and the description of the present disclosure. However, this is not intended to limit the embodiments according to the concept of the present disclosure to specific disclosure forms. It should be understood that the embodiments and the present disclosure include all modifications, equivalents, or substitutes included in the spirit and scope of the present disclosure.

Unless otherwise defined, the meaning of all terms including technical and scientific terms used herein is the same as that commonly understood by one of ordinary skill in the art to which the present disclosure belongs. It should be further understood that terms, such as those defined in commonly used dictionaries, should be interpreted as having meanings which are consistent with their meanings in the context of the relevant art and the present disclosure. Such terms should not be interpreted in an idealized or overly formal sense unless expressly so defined herein.

Hereinafter, the embodiments disclosed herein are described in detail with reference to the accompanying drawings, wherein identical or similar components are designated by the same reference numerals regardless of which drawings the components are shown. Further, duplicate descriptions thereof have been hereby omitted.

In the following description of the embodiments, the term “preset” means that, when a parameter is used in a process or algorithm, the value of the parameter is predetermined. The value of the parameter may be set at the start of the process or algorithm or may be set during an interval during which the process or algorithm is performed, depending on embodiments.

As used in the following description, the suffixes “module” and “part” for components are given or used for ease of description only and are not intended to have a distinct meaning or role in themselves.

In the description of the present disclosure, where it has been determined that the detailed description of the related art would obscure the gist of the present disclosure, the detailed description thereof has been omitted. In addition, the attached drawings are merely intended to aid in understanding the embodiments disclosed herein. Thus, the technical ideas disclosed herein are not limited by the attached drawings. It should be understood that the present disclosure includes all changes, equivalents, and substitutions included in the ideas and technical scope of the present disclosure.

Although the terms “first”, “second”, etc. may be used herein to describe various elements, these elements should not be limited by these terms. These terms are only used to distinguish one element from another element.

It should be understood that, when an element is referred to as being “connected” or “coupled” to another element, the element can be directly connected or coupled to the other element or intervening elements may be present therebetween. In contrast, it should also be understood that, when an element is referred to as being “directly connected” to another element, there are no intervening elements present.

As used herein, the singular forms “a”, “an”, and “the” are intended to include the plural forms as well, unless the context clearly indicates otherwise. Also, when a component, device, element, unit, part, module, controller, or the like of the present disclosure is described as having a purpose or performing an operation, function, or the like, the component, device, element, unit, part, module, or controller should be considered herein as being “configured to” meet that purpose or perform that operation or function. Further, the terms unit, module, part, controller, or the like, used in the present disclosure may signify one element that processes at least one function or operation, and may be realized by hardware, software, or a combination thereof. The operations of the method or the functions described in connection with the forms disclosed herein may be embodied directly in a hardware or a software module executed by a processor, or in a combination thereof.

In this specification, it should be understood that the terms “comprise”, “include”, “have”, and variations thereof, when used in this specification, specify the presence of stated features, integers, steps, operations, elements, components, and/or combinations thereof. Such terms do not preclude the presence or addition of one or more other features, integers, steps, operations, elements, components, and/or combinations thereof.

A gas station information-provision system according to embodiments of the present disclosure is proposed that may increase the effectiveness of personalized gas station advertisements by analyzing a vehicle's fueling history and providing gas station information about gas stations available for fueling using a particular fuel type depending on the analyzed fueling history.

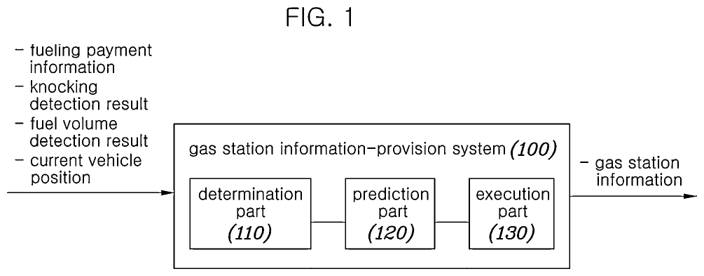

Hereinafter, before describing a gas station information-provision method according to an embodiment of the present disclosure, a configuration of a gas station information-provision system according to an embodiment of the present disclosure is first described with reference to FIG. 1.

FIG. 1 is a diagram illustrating a configuration of a gas station information-provision system according to an embodiment of the present disclosure.

Referring to FIG. 1, the gas station information-provision system 100 according to an embodiment of the present disclosure may include a determination part 110, a prediction part 120, and an execution part 130. The system 100 may have fuel payment information, a knocking detection result, a fuel volume detection result, a vehicle's current location, and the like as input information. The system 100 may have gas station information as output information.

The determination part 110, the prediction part 120, and the execution part 130 may each include a communication device to communicate with other controllers or sensors to perform the functions for which they are responsible, a memory to store operating system or logic instructions and input and output information, and one or more processors to perform determinations, operations, decisions, and the like necessary to control the functions for which they are responsible.

Meanwhile, FIG. 1 mainly shows configurations related to the description of an embodiment of the present disclosure. An actual system may be implemented including more or fewer components. Hereinafter, a respective configuration and its operation is described in detail.

First, the determination part 110 may determine a fueling history of the vehicle for or using a first fuel type among a plurality types of fuel.

In this case, the first fuel type may be different from a second fuel type. For example, the first fuel type and the second fuel type may be distinguished by an octane number. More specifically, in an embodiment of the present disclosure, the first fuel type may be defined as having a higher octane number than the second fuel type.

Here, the octane number is an indication of the knocking probability of an engine, which may be an indication of the performance characteristics of the fuel. The octane number for a fuel type may be derived through experimentation. It can be understood that the higher the octane number, the greater the resistance to knocking. Therefore, when using fuel with a higher octane number, the probability of engine knocking may be relatively lower.

In view of this, although not necessarily limited thereto, the first fuel type having a relatively high octane number may be understood to be a high-grade fuel and the second fuel type may be understood to be a regular or lower grade fuel.

On the other hand, the determination part 110 may determine a vehicle's fueling pattern for or with the first fuel type depending on the vehicle's fueling history using the first fuel type.

In this case, the vehicle's fueling pattern for the first fuel type may include at least one of a fueling cycle with the first fuel type, a fueling location with the first fuel type, whether a second fuel type is used among the plurality types of fuel, a fueling frequency with the first fuel type relative to the second fuel type. Various patterns may be derived through combinations of the above fueling cycle, location, etc.

For example, the patterns analyzed may include: a pattern of fueling with the first fuel type at regular intervals regardless of the remaining amount of fuel; a pattern of fueling with the first fuel type more frequently at certain fueling locations; a pattern of alternately fueling with the first and second types of fuel at irregular intervals; a pattern of fueling only with the second fuel type; a pattern of selectively fueling with the first fuel type or the second fuel type depending on the remaining amount of fuel, or the like. Although not illustrated by way of example, an infinite number of patterns may be analyzed depending on the combinations of input information.

In particular, the determination part 110 may analyze the fueling pattern depending on at least one of a payment history from a payment system associated with a vehicle to provide fueling payment services, a detection result from a knocking sensor disposed on a engine side of the vehicle to detect knocking occurring during operation of the engine, or a combination thereof.

In this case, the payment system may be configured such that at least some components of the payment system are mounted in the vehicle. The payment system may be implemented into an in-vehicle payment system, for example, providing payment services via an AVNT device without a physical card.

A vehicle user may pay for fuel through a payment system, such as an in-vehicle payment system. The payment history may be communicated from the payment system to the determination part 110, which may analyze the fueling patterns depending on the fueling payment history obtained from the payment system.

However, payment systems in which some components thereof are not always present in the vehicle may also be applied to embodiments of the present disclosure. Regardless of implementation, other payment systems such as payment systems in which some components thereof are implemented on a user's personal terminal, such as a smartphone, may also be applied, so long as they are able to provide the fueling payment history to the determination part 110.

Furthermore, the determination part 110 may determine the fueling history using the first fuel type depending on the number of knocking detections according to the detection result of the knocking sensor.

Since the number of knocking detections varies depending on the fuel type, the determination part 110 may determine the fuel type that has been used to fuel the vehicle depending on the number of times knocking occurs.

Furthermore, the determination part 110 may determine the fueling frequency with the first fuel type relative to the second fuel type depending on a change in the number of knocking detections as a result of the knocking detection.

For this purpose, the determination part 110 may store and/or learn the number of knocking detections. For example, if the current number of knocking detections differs from the previously stored and/or learned number of knocking detections, the determination part 110 may determine that the fuel type that was used to fuel the vehicle the last or previous time and the fuel type that is currently used to fuel the vehicle are different.

On the other hand, the determination part 110 may utilize both or either one of the payment history of the payment system and the detection results of the knocking sensor to determine the fueling history.

In particular, in an embodiment, if the determination part 110 cannot determine the fueling history through the payment system, the determination part 110 may first utilize the payment system by analyzing the fueling pattern through the detection result of the knocking sensor. On the contrary, if the determination part cannot determine the fueling history through the knocking sensor, the determination part 110 may analyze the fueling history by utilizing the payment history of the payment system.

Here, the cases in which the fueling history cannot be determined through the payment system may include: the case in which the payment system is not associated with a vehicle; the case in which the payment system has failed; the case in which, although the payment system is associated with a vehicle, the payment history does not exist in the payment system or it is insufficient to determine the fueling history; or the like. Particularly, in the case of a payment system, such as an in-vehicle payment system where at least some components thereof are provided in a vehicle, the case in which the fueling history cannot be determined through the payment system may include the case in which a payment system such as an in-vehicle payment system is not provided in a vehicle, is a determination target object for fueling history.

On the other hand, the determination part 110 may analyze the fueling pattern by further considering the payment history of the payment system, the detection result of the knocking sensor, and/or the detection result of the fuel sensor provided in a vehicle.

More specifically, the determination part 110 may determine at least one of a fueling location, a fueling time, or a combination thereof of a vehicle depending on a change in fuel volume detected by the fuel sensor to analyze the fueling pattern. For example, the determination part 110 may determine the fueling location depending on vehicle positions at the time of the increase in fuel volume and on the fueling time depending on the length of time the increase in fuel volume lasts.

In this way, the determination part 110 may derive various fueling patterns by combining the fueling location and fueling time of a vehicle, determined depending on the change in fuel volume, with the payment history of the payment system, the detection result of the knocking sensor, etc.

On the other hand, the prediction part 120 may predict the optimal fueling time for the first fuel type depending on the fueling pattern analyzed by the determination part 110. In other words, the optimal fueling time for the first fuel type, determined by the prediction part 120, may vary depending on the fueling pattern determined for the first fuel type.

In this case, the preset conditions according to the fueling history using the first fuel type may be determined to be satisfied or not according to the optimal fueling time.

For example, the execution part 130 may output gas station information about gas stations located around the current location of the vehicle at a time before a preset time from the optimal fueling time for the first fuel type, predicted through the prediction part 120 as described above.

By analyzing the fueling pattern of the first fuel type through the determination part 110 and predicting the optimal fueling time for the first fuel type through the prediction part 120 depending on the analysis, it is possible to determine the demand for the first fuel type. In addition, the execution part 130, as described below, provides gas station information corresponding to the determination, thereby providing customized advertisements suitable for the user.

Through customized advertisements based on fueling patterns, users may obtain gas station information at the time they need to fuel, or at an appropriately selected earlier time therefrom, without having to search for the information. Thus, users are able to drive efficiently in consideration of gas station stops or are able to select gas stations according to their preferences while being aware of the cost of fuel, the distance to travel for gas station stops, etc.

In addition, from the perspective of operators such as gas station operators commissioning advertisements, the customized advertisements based on fueling patterns may improve advertising effects. More customers may thereby be attracted, and sales may be increased accordingly.

In addition, from the perspective of platform operators, etc., providing advertisements, the customized advertisements based on fueling patterns may improve the matching ratio between fueling consumers, such as drivers, and fueling providers, such as gas station operators. The competitiveness of the platform is thereby enhanced.

In addition, through the provision of gas station information according to the disclosed embodiments, not only the above advertising effect, but also the effect of guiding the user to the appropriate fueling time may be derived.

On the other hand, the gas station information output by the execution part 130 may include at least one of brand information, location information, price information, discount information of gas stations, or any combination thereof. The output gas station information may include various information that may assist a user such as a driver in using or selecting a gas station, such as the fuel type handled by a particular gas station.

The execution part 130 may output gas station information about gas stations available for fueling with the first fuel type while being located around the current location of the vehicle.

In particular, the execution part 130 may output the gas station information so that the gas station information is recognized by at least one of visual sense, auditory sense, or any combination thereof within the vehicle. For example, the execution part 130 may output the gas station information to be recognized within the vehicle via an AVNT device, a user's personal terminal, an instrument cluster, a head up display (HUD), or the like. To do so, the execution part 130 may communicate with the vehicle, the personal terminal, or the like.

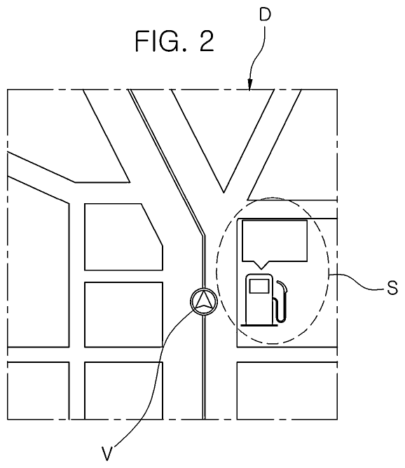

In this regard, an embodiment is described below with reference to FIG. 2.

FIG. 2 is a diagram illustrating a manner of providing a gas station information according to an embodiment of the present disclosure.

Referring to FIG. 2, in an embodiment, the execution part 130 may output gas station information S on a map screen D of a display device (including an AVNT device) provided in a vehicle. Thus, the gas station information S is displayed within a certain range based on the current location V of the vehicle displayed on the map screen D.

With the above and other similar embodiments, it is possible to provide gas station information such that a user, such as a driver, may intuitively check the gas station information while operating a vehicle. By doing so, it is possible to provide gas station information efficiently and effectively, thereby improving the effectiveness of customized advertisements based on fueling history.

Hereinafter, a process of providing gas station information through the gas station information-provision system 100 described above is described with reference to a flowchart.

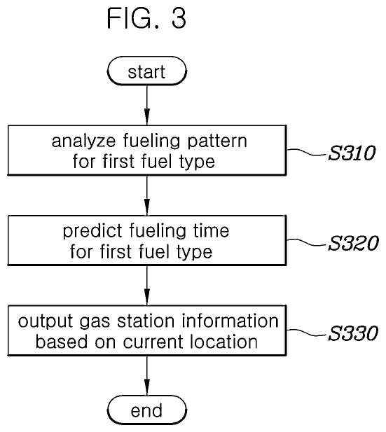

FIG. 3 is a flowchart illustrating a gas station information-provision method according to an embodiment of the present disclosure.

Referring to FIG. 3, the determination part 110 first analyzes the fueling pattern for the first fuel type (S310). In this process, the payment history of a payment system, the fueling history using the first fuel type determined by the knocking detection result of the knocking sensor, the fuel volume detection result of the fuel sensor, and/or the like may be utilized.

Next, the prediction part 120 receives the fueling pattern for the first fuel type analyzed by the determination part 110 and predicts the optimal fueling time for the first fuel type based on the fueling pattern (S320).

The optimal fueling time predicted via the prediction part 120 may be transmitted to the execution part 130. The execution part 130 may output gas station information based on the optimal fueling time and the current location of the vehicle (S330).

Meanwhile, the details concerning the embodiments of the gas station information-provision system 100 according to the present disclosure described with reference to FIGS. 1 and 2 may be applied to the gas station information-provision method according to an embodiment of the present disclosure, even for details not directly shown in the description with reference to FIG. 3.

According to various embodiments of the present disclosure, it is possible to provide customized gas station advertisements reflecting personal preferences by providing gas station information based on the fueling pattern of a user, such as a driver.

In particular, by analyzing the fueling pattern of high-grade fuel and providing gas station information accordingly, it is possible to provide effective customized advertisements to consumers of high-grade fuel.

In addition, it is possible to guide, to users such as drivers, the appropriate fueling time by using the fueling pattern and the gas station information.

In addition, by linking with an in-vehicle payment system, it is possible to induce the use of the in-vehicle payment system.

Although specific embodiments of the present disclosure have been described and illustrated, those of ordinary skill in the art should appreciate that various alternations and modifications are possible without departing from the technical spirit of the present disclosure as disclosed in the appended claims.

What is claimed is:

1. A gas station information-provision system comprising:
a determination part configured to determine a fueling history of a vehicle using a first fuel type among a plurality of types of fuel; and
an execution part configured to output gas station information about a gas station available for fueling with the first fuel type, if a preset condition according to the fueling history with the first fuel type is satisfied.

2. The gas station information-provision system of claim 1, wherein the first fuel type has a higher octane number than a second fuel type among the plurality of types of fuel.

3. The gas station information-provision system of claim 1, wherein the determination part determines the fueling history using the first fuel type from at least one of a payment history of a payment system associated with the vehicle to provide a fueling payment service, a detection result of a knocking sensor provided on an engine of the vehicle to detect knocking occurring during operation of the engine, or a combination thereof.

4. The gas station information-provision system of claim 3, wherein the payment system is configured such that at least some components of the payment system are mounted in the vehicle.

5. The gas station information-provision system of claim 3, wherein the determination part determines the fueling history using the first fuel type on the basis of a number of knocking detections according to the detection result of the knocking sensor.

6. The gas station information-provision system of claim 3, wherein, if the fueling history using the first fuel type is not obtained from the payment history of the payment system, the determination part determines the fueling history using the first fuel type from the detection result of the knocking sensor.

7. The gas station information-provision system of claim 1, wherein the determination part analyzes a fueling pattern with the first fuel type based on the determined fueling history using the first fuel type, and wherein satisfaction of the preset condition is determined based on the analyzed fueling pattern with the first fuel type.

8. The gas station information-provision system of claim 7, wherein the fueling pattern of the first fuel type includes at least one of a fueling cycle with the first fuel type, a fueling location with the first fuel type, a fueling history using a second fuel type among the plurality types of fuel, a fueling frequency with the first fuel type relative to the second fuel type, or any combination thereof.

9. The gas station information-provision system of claim 8, wherein the determination part determines the fueling frequency with the first fuel type relative to the second fuel type depending on a change in a number of knocking detections from the detection result of the knocking sensor.

10. The gas station information-provision system of claim 7, wherein the determination part further considers a detection result of a fuel sensor provided in the vehicle to analyze the fueling pattern with the first fuel type.

11. The gas station information-provision system of claim 10, wherein the determination part determines at least one of a fueling location, a fueling time, or a combination thereof of the vehicle depending on a change in fuel volume according to the detection result of the fuel sensor to analyze the fueling pattern with the first fuel type.

12. The gas station information-provision system of claim 7, further comprising a prediction part configured to determine an optimal fueling time for the first fuel type depending on the fueling pattern with the first fuel type analyzed by the determination part, wherein satisfaction of the preset condition is determined based on the optimal fueling time.

13. The gas station information-provision system of claim 1, wherein the gas station information includes at least one of brand information, location information, price information, discount information, or any combination thereof of the gas station.

14. The gas station information-provision system of claim 1, wherein the execution part outputs, among gas station information about gas stations available for fueling with the first fuel type, gas station information about gas stations located around the current location of the vehicle.

15. The gas station information-provision system of claim 1, wherein the execution part outputs the gas station information such that the gas station information is recognized within the vehicle via at least one of visual sense, auditory sense, or a combination thereof.

16. The gas station information-provision system of claim 15, wherein the execution part outputs the gas station information so that the gas station information is displayed on a map screen of a display device provided in the vehicle within a certain range based on the current location of the vehicle displayed on the map screen.

17. A gas station information-provision method comprises:
determining a fueling history of a vehicle using a first fuel type among a plurality types of fuel; and
if a preset condition according to the fueling history using the first fuel type is satisfied, outputting gas station information about gas stations available for fueling with the first fuel type.
